(19) United States
(12) Patent Application Publication
(10) Pub. No.: US 2015/0239599 A1
(43) Pub. Date: Aug. 27, 2015

(54) TRANSVERSELY DEFORMABLE BOTTLE

(71) Applicant: L'OREAL, Paris (FR)

(72) Inventors: Stephane Leroux, La Queue En Brie (FR); Patrick Charnay, Polliat (FR); Laurence Joly, Orry La Ville (FR); Gilles Baudin, Montigny-les-Cormeilles (FR)

(73) Assignee: L'OREAL, Paris (FR)

(21) Appl. No.: 14/422,742

(22) PCT Filed: Jul. 23, 2013
(86) PCT No.: PCT/EP2013/065554

§ 371 Date: Feb. 20, 2015

Related U.S. Application Data
(60) Provisional application No. 61/696,833, filed on Sep. 5, 2012.

(30) Foreign Application Priority Data
Aug. 22, 2012 (FR) 1257921

(51) Int. Cl. B65D 1/02; B67D 7/06; B65D 21/08; B65D 1/32

(52) U.S. Cl. CPC B65D 1/0223; B65D 1/32; B67D 7/06; B65D 21/086

(57) ABSTRACT

Bottle comprising:—a body (2) having a transversely deformable zone (1),—a cap member (3),—a product taking up between 25% and 98% of the internal volume of the body (2) of the bottle in the initial filling state of the bottle.

The present invention relates to the packaging of products, in particular cosmetic products.

The invention relates more particularly to the packaging of hair dyeing products in flexible-walled bottles, in particular oxidation dyes. These products are typically packaged with a bottle filling volume of around 25 to 70%, since a free space sufficient for extemporaneous mixing with another component should remain.

Some factories are located at altitude, where there prevails an atmospheric pressure lower than at sea level, and this can cause a problem when the bottle packaged at altitude is then located at sea level and there is a difference in pressure between the inside of the bottle and ambient pressure, this tending to deform the bottle, giving it an unattractive appearance.

A known solution for avoiding this problem is to introduce liquid nitrogen into the bottle after it has been filled with the product, the evaporation of this liquid nitrogen after the bottle has been closed compensating for the lower atmospheric pressure during packaging.

However, this solution is relatively complex and costly to implement.

Another problem that is encountered is the creation of an overpressure in the bottle on account of a rise in temperature during storage.

There thus exists a need for a novel bottle and a packaging method for remedying the above drawbacks.

Containers having a bellows are known from FR2456667, EP804367, FR1449600, U.S. Pat. No. 4,177,939, U.S. Pat. No. 6,170,712 and W02006/11473.

FR2456667 describes a bottle having a compressible part that is actuable by a control lever in order to reduce the force necessary for decreasing the internal volume of the bottle in order to dispense the contents thereof.

EP804367 discloses a bottle intended to contain a liquid for therapeutic use for the nose or ears. The bottle is provided, over its entire height, with a bellows for retracting the bottle in order to progressively and then totally empty it. The bottle is initially filled virtually to the brim.

FR1449600 describes a bottle intended to contain a product for intravenous injection. A bellows makes it possible to reduce the volume of gas above the liquid during its consumption, in order to avoid it escaping. There again, the bottle is initially filled to the top.

U.S. Pat. No. 4,177,939 discloses a bottle with a bellows, intended in particular for packaging a nasal spray, and aims to make it easier to empty said bottle. The presence of the bellows makes it possible to decrease the internal volume of the bottle as it is emptied and to avoid the deterioration of the product on contact with air that has passed into said bottle. There again, the bottle is initially filled to the top.

U.S. Pat. No. 6,170,712 discloses a bottle provided with a bellows, more particularly intended for packaging viscous food products such as sauces. This bottle is intended to be compressed by the user in order to dispense the product. It returns to its initial shape as soon as the user stops the compression. It is then ready for a new compression/decompression cycle. There again, the bottle is initially filled to the top.

WO2006/11473 discloses a bottle provided with a bellows for an ocular liquid in order to reduce the pressure exerted by the user to expel the liquid from the bottle.

The subject of the invention is a bottle comprising:
a body having a transversely deformable zone,
a closure member,
a product initially taking up between 25% and 98% of the internal volume of the body of the bottle.

The expression “to deform transversely” should be understood as meaning to deform perpendicularly to the longitudinal axis of the bottle, in particular approximately perpendicular to the longitudinal axis of the neck.

The expression “initially taking up” should be understood as meaning at the end of filling of the bottle, while it is being packaged, before said bottle is closed.

In particular, the product initially takes up between 25% and 92% of the internal volume of the body of the bottle.

Advantageously, the product takes up between 35% and 60% of the internal volume of the body of the bottle in the initial filling state of the bottle.

By virtue of the invention, the bottle can be filled with the product at altitude with no fear of the bottle deforming when it is returned to sea level, such a deformation impairing the appearance of the bottle, in particular in the cylindrical areas, in particular the areas that can be labeled and are most visible to the consumer, or impairing satisfactory use of the bottle. The invention thus makes it possible to carry out packaging at altitude, preferably up to 3660 meters (altitude of La Paz) and more preferably up to 2500 meters.

Advantageously, the transversely deformable zone is designed such that an increase in atmospheric pressure of between 10% and 30% causes a decrease of between 1.3% and 4% in the internal volume of the body of the bottle.

With such a deformation, the bottle retains an attractive appearance after it has been transported from a manufacturing plant located at altitude to the valley.

Advantageously, the transversely deformable zone comprises a bellows.

By retracting, the bellows allows the internal volume to decrease when the external pressure is greater than the internal pressure. Thus, the bellows is molded with a shape that allows it to retract, with for example lᵢ/l_{g}>1.5, where is the initial axial dimension of the bellows, in the state in which it is filled, and l_{g} is its axial dimension in the state retracted to the maximum.

For example, 1.5≦lᵢ/l_{g}≦5.

Advantageously, the transversely deformable zone can expand between a position of maximum retraction and a position of maximum relaxation in order to modify the total volume of the bottle by a value of between −4% and +10%, the reference value 0 corresponding to the position of expansion of the bottle initially, just after it has been filled.

The bottle can thus generally maintain its appearance in spite of being packaged at altitude, and it is no longer necessary to add liquid nitrogen at the time of packaging.

Before it is opened for the first time, the bottle has an air cushion above the product on account of liquid nitrogen not being introduced at the time of packaging.

In addition, in the event of a temperature rise during storage, the bellows can expand and the development of an overpressure can be avoided.

Advantageously, the transversely deformable zone is molded in one piece with the body, in particular from the same thermoplastic material, for example, LDPE, HDPE, PET, a mixture of LDPE and HDPE, or PP. The thickness of the material in the deformable zone is for example between 0.1 and 1 mm.

Advantageously, the deformable zone takes up at least 50% of the overall height of the internal volume of the bottle after the latter has been opened.

Such expansion of the bottles during the descent to sea level is optimal in order to minimize the volume of convoys during transport.

More advantageously, the deformable zone also extends over the bottom of the bottle, in order to avoid excessive stresses being exerted in that region.

The body of the bottle may be surmounted by a neck for fastening a dispensing cannula or a cap.

If need be, the bottle is closed by a cap and it is provided to the user with a dispensing cannula which the user fits on the neck by replacing the cap when the bottle is used for the first time.

In particular, the total internal volume of the bottle may be between 50 cm³ and 1100 cm³, in particular between 100 cm³ and 250 cm³.

The variation in the internal volume of the bottle, which is around 190 ml and has a cross section contained in a disk, said variation being caused by the transverse deformation of the bellows between a configuration of extreme retraction of the bellows and a rest configuration with the bottle open, ranges for example between 10% and 25% of the total internal volume of the bottle in the state in which the bellows is at rest in its initial configuration and the bottle is open. This variation in volume corresponds for example to a volume between 25 cm³and 40 cm³.

The product contained in the bottle may be an oxidation hair dye.

The number of folds in the bellows may be between two and six, better still between three and five. When the bottle is closed and contains the product, prior to being used for the first time, the pressure inside the bottle is for example less than ambient atmospheric pressure at 20° C., which is taken to be 1013.25 mbar (1.01325×10⁵ Pa). The bellows may have shape memory and may extend by itself when the bottle is opened.

A further subject of the invention is a method for packaging a cosmetic product, in particular an oxidation dye, comprising:
a step of introducing the product into a bottle body as defined above, when an atmospheric pressure less than or equal to 850 mbar, in particular between 850 and 650 mbar (or hPa) is prevailing,
a step of closing the bottle, preferably without addition of liquid nitrogen.

Advantageously, the method further comprises a step of transporting the bottle to a distribution location, the distribution location being located at an atmospheric pressure of between 1015 hPa (atmospheric pressure at sea level: altitude 0 meter) and 682 hPa (atmospheric pressure at La Paz).

According to a first embodiment of the invention, the product is introduced into the bottle at a temperature of between 15° C. and 25° C. and initially takes up between 25% and 70% of the internal volume of the body of the bottle. In particular, the product is an oxidation dye.

According to a second embodiment of the invention, the product is introduced into the bottle at a temperature of between 40° C. and 80° C. and initially takes up between 25% and 90% of the internal volume of the body of the bottle. In particular, the product is an oil.

The invention may be better understood from reading the following detailed description of a non-limiting implementation example of the invention and from examining the appended drawing, in which:

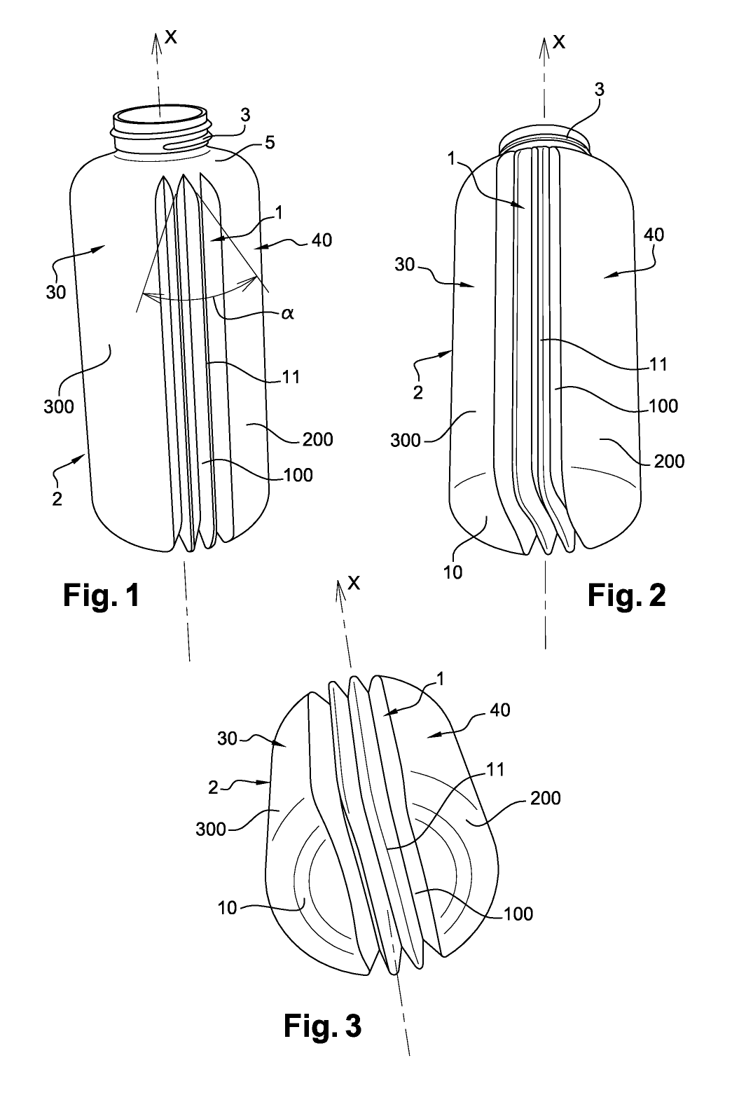

FIG. 1 shows a perspective front view of the body of a bottle according to the invention, and

FIG. 2 shows a perspective inclined front view of the body of the bottle according to FIG. 1,

FIG. 3 shows a perspective bottom view of the body of the bottle according to FIG. 1.

The bottle body 2 shown in FIGS. 1 to 3 is generally in the form of a cylinder of revolution about the longitudinal axis X. At its lower end, it is connected to a bottom 10 which allows the bottle to stand vertically on a horizontal planar surface. At its upper end, it may be closed by a closure member fitted on the threaded neck 3. The closure member consists for example of a cap, possibly provided with a dispensing cannula. Another example could be a heat-sealed or welded membrane seal.

The invention is not limited to a particular closure means and the bottle can be closed by a simple cap, without a dispensing cannula. As a variant, the bottle is closed by an end piece which is screwed onto a cannula.

The body 2 comprises a transversely deformable zone 1.

As can be seen, the zone 1 is produced with a bellows 100 comprising folds 11, for example between 2 and 6 folds. In the initial state, with no deformation of the bellows 100, the angle α formed by two adjacent folds is for example between 30 and 60°, being for example around 40°.

The bellows 100 is in the non-refracted initial state just after the product has been packaged in the bottle.

The bottle 2 contains a product P which is, for example, an oxidation hair dye, although the invention is not limited to the packaging of a particular product.

The product P initially takes up, for example, between 25% and 70%, or even between 25 and 60%, of the total internal volume of the bottle 2. The total internal volume is the volume determined by the amount of liquid which the open body 2 can hold until it is filled to the brim of the neck 3, the height of the product contained inside the container then being H.

In the example in FIG. 1, the bellows 100 diametrically crosses the bottom 10 of the body 2 and extends vertically from one side of the bottom to the other over the entire height of the cylinder as far as the shoulder 5. In this example, the bellows 100 separates the cylindrical part of the body 2 into two symmetrical portions 30 and 40 of axis X.

If the bottle is moved to sea level in order to be dispensed, after the product has been packaged at altitude, the pressure when the product is dispensed is greater than that prevailing during the closure of the bottle. The bellows 100 retracts transversely and the folds 11 move closer together at the atmospheric pressure at sea level. This deformation of the bottle makes it possible to reduce the pressure imbalance between the pressure of the gas cushion above the product and atmospheric pressure. On account of the presence of the bellows 100, the deformation of the bottle is limited substantially to the zone 1, such that the bottle can maintain two regions 200 and 300 having an appearance that is substantially non-deformed.

In order to use the product, the user opens the bottle, for example by removing an end piece or by unscrewing a cap. The opening of the bottle is accompanied by the return of the bellows 100 to its molded configuration by shape memory. The user can pour all of the product for example into a bowl, or only pour out a part and close the bottle again.

During use, the presence of the bellows 100 also gives the body 2 of the bottle a certain flexibility, thereby increasing ease of use.

The invention is not limited to the exemplary embodiment illustrated. For example, the bottle can be produced with a zone 1 other than a bellows and/or having a different shape, in particular with a transversely deformable zone having a different height or different width from the one shown.

The bottle may be equipped with a bellows 100 in its lower part, and not in its upper part. As a variant, the bottle may be equipped with two separate bellows, one in its lower part and the other in its upper part.

The expression “comprising a” should be understood as being synonymous with “comprising at least one”. The ranges of values indicated should be understood as including the limits unless specified to the contrary.

1.-13. (canceled)

14. A bottle comprising:
a body having a transversely deformable zone;
a closure member; and
a product initially taking up between about 25% and about 98% of an internal volume of the body of the bottle.

15. The bottle of claim 14, wherein the product is an oxidation dye and initially takes up between about 25% and about 70% of the internal volume of the body of the bottle.

16. The bottle of claim 14, wherein when the product is introduced at a temperature ranging from about 40° C. to about 80° C., the product initially takes up between about 25% and about 90% of the internal volume of the body of the bottle.

17. The bottle of claim 14, wherein the transversely deformable zone is configured such that an increase in atmospheric pressure ranging from about 10% to about 30% causes a decrease ranging from about 1.3% to about 4% of the internal volume of the body of the bottle.

18. The bottle of claim 14, wherein the transversely deformable zone comprises a bellows.

19. The bottle of claim 14, wherein the product takes up between about 35% and about 60% of the internal volume of the body of the bottle in an initial filling state of the bottle.

20. The bottle of claim 14, wherein the transversely deformable zone is molded in one piece with the body.

21. The bottle of claim 14, wherein the transversely deformable zone is configured to be expandable between a position of maximum retraction and a position of maximum relaxation in order to modify the internal volume of the bottle by a value ranging from about −4% to about +10%.

22. The bottle of claim 14, wherein the transversely deformable zone takes up at least about 50% of an overall height (H) of the bottle.

23. The bottle of claim 14, wherein the body is surmounted with a neck configured to allow the closure member to be fitted thereon.

24. The bottle of claim 14, wherein the internal volume in the initial filling state ranges from about 50 cm³ to about 1100 cm³.

25. The bottle of claim 14, wherein the internal volume in the initial filling state ranges from about 100 cm³ to about 250 cm³.

26. A method for packaging a cosmetic product, comprising:
introducing the cosmetic product into a bottle including a body having a transversely deformable zone, when an atmospheric pressure less than or equal to about 850 hPa is prevailing; and
closing the bottle.

27. The method of claim 26, further comprising:
transporting the bottle to a distribution location, the distribution location being located at an atmospheric pressure ranging from about 1015 hPa to about 682 hPa.

28. The method of claim 26, wherein introducing the cosmetic product into the bottle comprises introducing the cosmetic product into the bottle when the atmospheric pressure ranges from about 850 hPa to about 650 hPa.

29. The method of claim 26, wherein closing the bottle comprises closing the bottle without addition of liquid nitrogen.
